(19) United States
(12) Patent Application Publication
(10) Pub. No.: US 2016/0095182 A1
(43) Pub. Date: Mar. 31, 2016

(54) LIGHT CONTROL MONITORING SYSTEM

(71) Applicant: SENECO A/S, Hasselager (DK)

(72) Inventors: Lars Norgaard Bjorn, Ronde (DK); Dan Staerk, Arhus C (DK); Kaspar Raahede Aaroe, Hinnerup (DK); Mikkel Aunsbjerg Jakobsen, Arhus C (DK)

(73) Assignee: Seneco A/S, Hasselager (DK)

(21) Appl. No.: 14/891,099

(22) PCT Filed: May 13, 2014
(86) PCT No.: PCT/EP2014/059705

§ 371 Date: Nov. 13, 2015

(30) Foreign Application Priority Data
May 13, 2013 (DK) 2013-70260

(51) Int. Cl. H05B 33/08; H05B 37/02

(52) U.S. Cl. CPC H05B 33/0854; H05B 37/0227; H05B 37/0272

(57) ABSTRACT

The present invention relates to a street light comprising means for determining a traffic related activity and control means for operating the street light according to the determined traffic related activity. A corresponding method for operating a street light is also disclosed.

### FIELD OF THE INVENTION

The present invention relates to a Light Control Monitoring System (LCMS) for operating a light source. More specifically, the present invention relates to a control scheme that may be applied in street lights in order to save power. The invention further relates to a street light being capable of being operated in accordance with said control scheme.

### BACKGROUND OF THE INVENTION

Various types of controllable street lights and associated methods have been suggested over the years.

One approach is suggested in GB 2 457 971 where a LED-based street light is controlled during dusk/dawn hours by increasing/decreasing the light level of the street light.

It appears that only control of a single and isolated street light is disclosed in GB 2 457 971. Thus, having a network of street lights the method and arrangement suggested in GB 2 457 971 do not offer an efficient power saving scheme during dusk/dawn hours.

Moreover, light intensity control of street lights in response to artificial illumination, such as manmade traffic illumination, appear not to be addressed in GB 2 457 971. Thus, the scenario where a street being at least partly illuminated by vehicle head lamps is not dealt with in GB 2 457 971.

It may be seen as an object of embodiments of the present invention to provide street lights and associated methods for operating such street lights in a manner so as to save power.

It may be seen as a further object of embodiments of the present invention to provide street lights and associated methods for operating such street lights efficiently by taking into consideration background artificial illumination.

### DESCRIPTION OF THE INVENTION

The above-mentioned objects are complied with by providing, in a first aspect, a method for operating a light source order to reduce power usage, the method comprising the steps of
determining a predetermined traffic related activity, and
operating the light source in accordance with said determined traffic related activity.

A traffic related activity may be any activity relating to traffic at or near the position of the light source, such as density of vehicles, number of pedestrians, number of cyclists etc. Also, a traffic related activity may be an indirect measure for the before-mentioned density, such as a total amount of light emitted from vehicles being at or near the location of the light source.

In order to save power the light intensity of the light source may be varied in accordance with the determined traffic related activity. Thus, the more background illumination from for example vehicles the less light is to be generated by the light source.

Determination of the traffic related activity may comprise a determination of an amount of traffic at or near the location of the light source. Alternatively or in combination therewith, the determination of the traffic related activity may comprise a determination of a light intensity generated by the traffic at or near the location of the light source. Such as light intensity may be the sum of the measured light from for example vehicles passing by the light source. The light source may form part of a street light. The light source itself may be a LED.

The phrase “at or near the location of the light source” should be understood as follows. The term “at” may involve a position directly below the light source, whereas the term “near” may involve positions around the light source, i.e. within a given radius from the light source.

This radius may depend on the distance from the light source to a neighbouring light source in case the latter exists. The radius may for example correspond to half the distance between two neighbouring light sources.

The light source may thus be operate in accordance with one or more control signals provided by one or more sensors selected from the group consisting of: light sensor, photovoltaic sensor, temperature sensor, vibration sensor, sound sensor, pressure sensor, moisture sensor, humidity sensor, motion detection sensor, PIR sensor, radar sensor, gyro sensor, accelerometer, ice detector, electrical signal and wind/airflow sensor.

The light source may be operated in a so-called constant light mode. In this mode of operation the light intensity on for example the surface of a street is kept at an essentially constant level. Thus, the light source is controlled in accordance with a detected intensity of background light which may originate from artificial light or natural light or a combination thereof.

In a second aspect, the present invention relates to a street light comprising a light source, said street light further comprising
means for determining a predetermined traffic related activity, and
control means for operating the light source in accordance with said determined traffic related activity.

Again, the control means may be adapted to vary the light intensity of the light source in accordance with the determined traffic related activity.

Similar to the first aspect the street light may further comprise means for determining an amount of traffic at or near the location of the light source. Means for determining a light intensity generated by the traffic at or near the location of the light source may be provided as well.

The street light may comprise one or more sensors selected from the group consisting of: light sensor, photovoltaic sensor, temperature sensor, vibration sensor, sound sensor, pressure sensor, moisture sensor, humidity sensor, motion detection sensor, PIR sensor, radar sensor, gyro sensor, accelerometer, ice detector, electrical signal and wind/airflow sensor.

The street light may comprise a light source in the form of a LED. Moreover, communication means for communicating with one or more other street lights may be provided. The communication means may comprise a wireless communication unit adapted to communicate with one or more neighbouring street lights in a wireless manner.

The street light may further comprise a power generating unit, such as a photovoltaic module or a wind power generator. Power generated by this power generating unit may be used for powering the light source in general, driving the light source or it may be saved in a power reservoir.

In a third aspect the present invention relates to a network comprising a plurality of street lights according to the second aspect. As it will be explained later the plurality of street lights may communicate in accordance with a predetermined method.

The following description relates to some particulars of the present invention, such as time/date calculations, constant lumen output, communication between street lights etc.

The overall advantage of the present invention relates to the possibility of reduced power usage and maintenance cost which is in line with the preferences of modern lighting. Furthermore, if the control unit is controlling a dimmable LED luminaire, the control unit can ensure constant lumen output.

A method of calculating the time of day and a method of connecting multiple control units in a network which has the ability to handle retransmissions, handling of unresponsive “network nodes” and duplicate network packages are also included in the present invention. Furthermore, a method of dynamically configuring network of nodes based on node location after node deployment is also described.

The present invention comprises a control unit that can reduce the power usage of a connected load by a control signal, or by altering the power output. The power usage of the load which may be a LED luminaire can be reduced by dimming the control output(s) and only raise the control output(s) when an internal or external sensor is activated. This sensor may be a light detector, photovoltaic, temperature sensor, vibration sensor, sound sensor, pressure sensor, moisture sensor, humidity sensor, motion detection sensor, PIR sensor, radar sensor, gyro sensor, accelerometer, ice detector, electrical signal, wind/airflow sensor etc.

A new method of measuring the current consumption of the load connected to the control unit is also presented; this method utilizes the thermal characteristic of current flowing through a known resistive device and thereby a stable low cost current measuring mechanism is presented which incorporates galvanic separation, and thus also is suitable for ac mains current measurement.

The invention also includes a new method of ensuring Constant Lumen Output (CLO) if the control unit is fitted with a LED luminaire. Since the light output of LED's decreases over the LED's lifetime but also is affected by the power delivered to the LED's and the ambient and LED temperature, this invention diverge from previously known methods by taking all of the above mentioned factors into account, and not only counting the hours of LED usage.

If the control unit is not connected to a power source at all times maintaining the control unit's knowledge of a precise time and date may be difficult. This invention presents a method of identifying the time and date by using a twilight switch, external signal and or the power on/off times. This feature may be used reduce the power delivered to the load connected to the control unit at a given time, or other time sensitive operations even without the control unit being constantly connected to a power source.

The present invention also presents a network protocol based on a graph structure for wireless, wired and other communication mediums, where the network graph is based on the geographical location of the networked nodes.

A method for a dynamic, post-deployment network configuration, by which the wired/wireless network links between nodes can be formed, based on arbitrary user selected patterns, such as the geographical layout of the area of deployment, is also included in the invention.

In other network topologies, the geographical location of the networked nodes is not taken into consideration when passing messages; instead message routing is optimized for maximising throughput or minimizing packet delay. For some applications such as, but not limited to street light controllers, minimizing packet delay and maximising throughput is not important, instead the sequence in which a given message is received by each recipient is of high importance. One example of this could be in an intelligent street lighting system, where each lighting element is controlled by a networked control unit. Light poles are often placed along streets, and it is expected that the individual lights are turned on in a graceful, predefined sequence starting from one end of the street and ending in the other end of the street, handling any intersecting streets along the way.

When a network node receives a network message from a neighbouring node in the network graph, the receiving node will acknowledge the proper reception of the transmitted network message, by transmitting a special acknowledgement packet to the transmitting network node.

If a network node is unable to receive or respond to packets from other networked nodes, it may be necessary for the transmitting network node to find an alternate route to the target node. The transmitting node can use the network graph to locate all network nodes that are adjacent to the unreachable node. The transmitting node may then attempt to transmit the packet directly to these adjacent nodes, so that the network does not become divided into several non-connected segments because of an unreachable network node.

If the adjacent nodes are unreachable themselves, the transmitting node can repeat the process of locating nodes adjacent to the unreachable node neighbouring the first unreachable node. This process of routing packets around unreachable nodes via adjacent nodes can be repeated any number of times, and thereby provides a very robust network.

Many communication protocols specify MAC level addressing, where the MAC addresses are globally unique and provided by the MAC hardware manufacturer. It is often desirable to be able to address any given node by a simpler symbol than its MAC address, for example by a network id that could be an integer in some arbitrary predefined interval. This requires a mapping to be made between the MAC address and the network id, and a method for making this mapping needs to be made. Furthermore, in order for a node to be able to address a neighbouring node, the neighbouring nodes id and MAC address must be known.

In some network applications, it is not possible or feasible to configure the network links before deploying the nodes. Furthermore, some network applications require intimate knowledge of the individual nodes geographical location, which may or may not be specified before deployment. Some network applications require that network links between nodes follow some geographical pattern, such as streets or river systems. Finally, some network applications are complicated by the inability or infeasibility of pre-deployment network configuration and the requirement of having the network links between nodes follow some specific geographical pattern.

The configuration process can be user initiated, and will usually be started after deployment of the network nodes to their final geographical location. The user could initiate the configuration of a given node by activating the node and instructing it to go into a configuration mode. When a node is in the configuration mode, the user can transmit a network id to the node.

### BRIEF DESCRIPTION OF THE DRAWINGS

The present invention will now be described in further details with reference to the accompanying figures, where

FIG. 1 shows a system overview,

FIG. 2 shows the principle of a printed circuit board (PCB) mounted thermal current measurement,

FIG. 3 shows the principle of varying light hours/day

FIG. 4 shows the principle of a normal wireless communication scenario,

FIG. 5 shows the principle of the wireless communication scenario “one unit unreachable”,

FIG. 6 shows the principle of the wireless communication scenario “two units unreachable”,

FIG. 7 shows an overall configuration process activity diagram,

FIG. 8 shows a node id assignment activity diagram, and

FIG. 9 shows a neighbourhood discovery activity diagram.

While the invention is susceptible to various modifications and alternative forms specific embodiments have been shown by way of examples in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

In general the present invention relates to a light unit, such as a street light, and an associated method for operating said light unit in a manner so as to save power. The following description discloses various features and methods relating to the light unit according to the present invention. These features and methods are generally combinable.

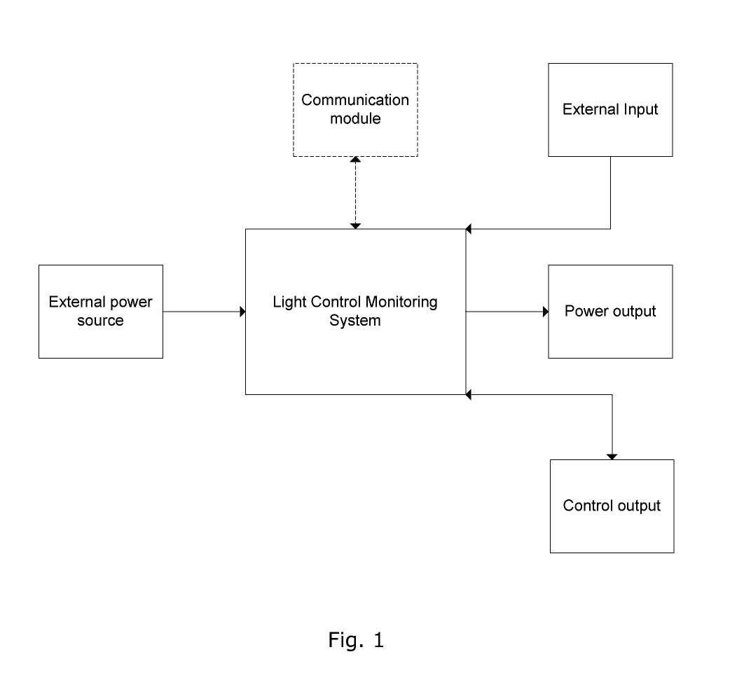

FIG. 1 shows the principle of the LCMS according to the present invention. An external power source may be the power grid, a dedicated power output of a LED driver or a dedicated power supply. The communication module is optional and is used to interconnect LCMS' or to remotely monitor and/or control one or more other LCMS'. The external input, which may be a motion detector, may affect the output of one or more LCMS'. The power output(s) may be powered by the input source or an internal power source or an altered version of the power source. The control output(s) which may be powered by an internal or external source, or the connected device, may be a voltage control, current control or a communication protocol.

The LCMS utilizes a method of monitoring the “health” of the connected equipment, by monitoring the current and or voltage of the power output.

Thermal Measurement of Current and Voltage.

When measuring ex. AC mains voltage by a “low voltage” DC circuit device, an issue might be to get the measurement device (mains side) (galvanic)isolated from the measurement circuit (low voltage side).

The commonly used solutions such as opto-couplers or transformers are usually quite costly, so a new low cost solution should have its place.

The principle of the new measurement method is to measure a rise in temperature when a power is dissipated through one or more resistive element(s) which may be resistors or PCB tracks or other. In the following a resistor will be used as an example.

For current measurement the resistor(s) may be placed in series with the load and for voltage measurement the resistor(s) may be placed in parallel with the load.

A thermal sensitive element which may be a thermistor is placed close to or on the opposite side of a plane ex. a PCB in order to detect the temperature rise in the measurement resistor. A rise in current or voltage will dissipate more power in the measurement element which will dissipate more heat. The thermal sensitive element will be able to detect the dissipated heat, and thereby measure the current or voltage.

A good thermal coupling between the measurement resistor and the thermal sensitive element is essential for precise measurements. This may be ensured by thermally connecting the measurement resistor and the thermal sensitive element with ex. Gap pad or thermal conducting paste or other thermally conducting materials.

Another method may be to use copper layers in a PCB to conduct the heat without physically/electrically connecting the measurement resistor and the thermal sensitive element.

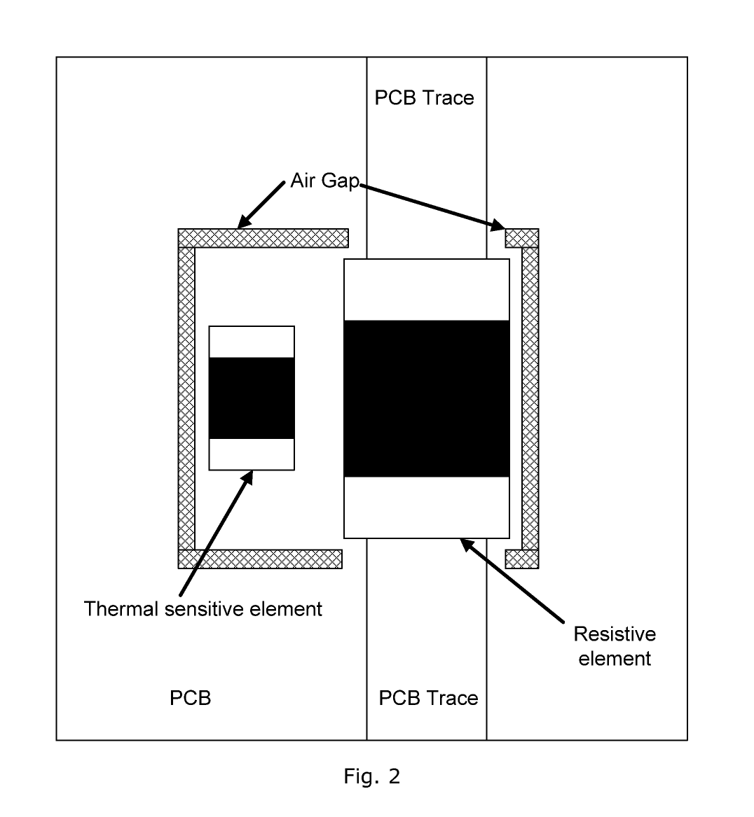

To insulate the measurement resistor and the thermal sensitive element from dissipating their heat into the surroundings ex. the PCB, an air gap may be introduced around the measurement resistor and the thermal sensitive element. The principle of current measurement is shown in FIG. 2.

The above mentioned is not restricted to AC current/voltage, but may also be incorporated in DC circuits.

External Sensor

The LCMS may be fitted with one or more external sensor(s), which may be a Passive Infrared Sensor (PIR). The input from the external sensor may be used to affect the control and/or power output of the LCMS. If connected to ex. a LED luminaire, the input from the external sensor may be used to increase the light output from the LED luminaire when affected, and when the input is not affected the light output may return to its previous level, thereby reducing light pollution when ex. no sensor input is affected around the luminaire and the need for light is reduced.

Furthermore, if multiple LCMS' are connected in a network, an input from one or more external sensors may affect other units in the network. This may be used if ex. a motion is detected by unit 1 which may increase the light output if ex. a LED luminaire is connected, and through the network units 2 and or 3 etc. also increase the light output, thereby the light can “follow” a moving object and the influence of reduced light output will be minimal to the user. This is useful in situations where minimum requirements for lighting levels apply, as well as requirements that limit power usage and light pollution.

Different types of sensors may be used; if ex. a grid divided motion detector, or another type of motion detector that can distinguish between object sizes is connected, the LCMS can determine ex. the type of traffic and thereby it may use different control output settings, or the detector can be used to detect/count the number of different objects during a period of time.

Constant Lumen Output

When a lamp is used the lumen output decreases over time. But it is not only the usage of the lamp over time that changes the lumen output; the ambient temperature and the power through the lamp are also factors that change the lumen output.

When the temperature, the power through the lamp and the light hours of the lamp is known, this information could be used to increase or decrease the power to the lamp to insure constant lumen output. Temperature, lamp power and light hours could be measured as frequently as needed and the information could be saved and used to compensate for temperature changes to ensure a constant lumen output at all times.

The lifetime of different light types like LED changes with the amount of current that they are driven at. When measuring the current through the lamp at all time the, lifetime and the light level can be determined.

Control Unit with Luxmeter

Most places—the street light is turned on/off with the input of a twilight switch. When it starts to get dark the switch changes state and the street light will be turned on. This is an on/off operation. With the twilight switch placed in a fuse box.

By measuring the light intensity with a lux meter, such as a photovoltaic cell, a light dependent resistor or similar light detecting device, during the day, it is possible to adjust the street lights light level in a continuous way. This gives means when it starts to get dark a control unit which may be placed in the fuse box, could adjust the light level on the street lights. Starting at a low light level, and slowly increase the light level as it gets darker. This control unit knows the light output of the luminaires, and can with this information and the current light intensity insure a correct lux level on the street.

The control unit placed in the fuse box may control the street light with a wired or wireless way.

With this invention it is possible to save energy around sunrise and/or sunset. It also insures a correct level of light on the street, so any legal requirements can be fulfilled.

Traffic Based Light Intensity

A control unit placed for example in the luminaire with a type of sensor that can count the traffic on the street. The sensor could be a PIR, radar, camera or similar. Based on the counted traffic the control unit adjusts the light intensity in the luminaire with a dimming signal 1-10V, dali, DMX-512, PWM or other communication methods.

Based on user settings in the control unit, the user can specify an average number of road users that needs to pass the sensor (luminaire) every hour to insure a specific light level. It could also be possible to adjust the initial-, minimum- and maximum light intensity, how fast it should increase/decrease light level after detecting road users.

The advantage with this functionality is the ability to adapt to the variation in the traffic, and by this save energy, and insure light when needed.

By having a 230V AC signal line input/output in the control unit, it will make it possible for one unit to control other luminaires or control units. This means if one unit detects some sort of motion, it could set the AC signal line high. This high signal will be detected by the other control units, and they will also control their luminaire.

The 230V AC output of the control, could also be used to supply the LED driver in the luminaire. This will save even more energy.

The term traffic should be interpreted broadly. Hence, the term traffic may relate to a number of cars, pedestrians, cyclists, runners etc.

Radio Frequency Communication

With a simple radio frequency (RF) module placed in the control unit, it will be possible to communicate with other units wirelessly. When one control detects a movement/motion, it will send out a message to the surrounding units wirelessly that it has detected a motion. Then the surrounding units will turn on/dim up their luminaire.

By increasing/decreasing the output power from the RF module, it will be possible to turn on more/fewer luminaires around the detected one.

This invention makes it possible to implement a simple control system that insures a high energy saving, where the customer can place the control units in a randomly order and still get a system that turns on the light around the road user and by adjusting the signal power in the RF module—turn on more/fewer luminaires.

Determining Time and Date

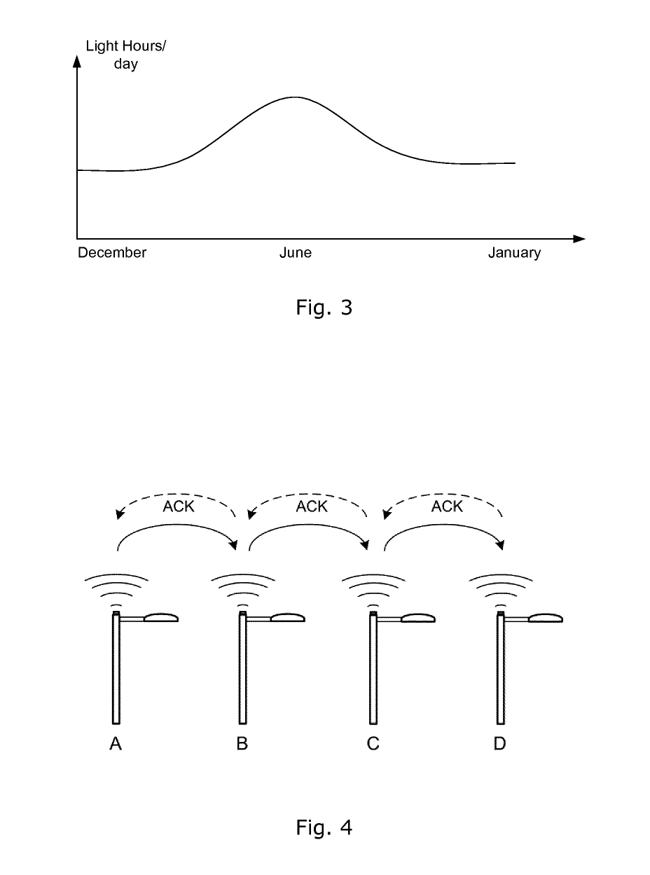

The invention uses the light or night hours per day to determine the time of the day, cf. FIG. 3. When knowing the length of the light or dark hours and the regional location of the system, it is possible to calculate the time of day. The light or dark hours may be detected by a twilight switch, turning on/off the power, external signal or other. The length may be saved in a microprocessor or another electronic component. When saving the length of the day or night time for a number of periods, this information can be used to determine the date of the year. By looking over several periods it is also possible to determine if the day or the night time gets longer, and by knowing the day/night time length the date can be calculated. When knowing the date—the time of sunrise and sunset can be calculated. And with this information the time is known. The calculation may be done by using a look-up table for the specified region, or a mathematical function for the whole year, which is used to calculate the time.

The time information may be used to differentiate light levels at specific hours or similar.

Network

The interconnection of LCMS' in a network will provide great flexibility for controlling, monitoring and configuring the LCMS's and their attached equipment remotely. This provides the possibility to exchange data between units, which will be of high priority if the information exchanged as an example is the switching on/off of a luminaire. The following describes a number of new approaches to network robustness.

Network Graph

The links between networked nodes are established based on a network graph. The nodes and edges of the network graph itself can be based on the geographical location of the networked nodes, assuming that the networked nodes are of a stationary nature.

Retransmissions

When a node A has transmitted a packet to a neighbouring node B, node A expects the receiving node B to indicate successful reception of the transmitted packet, by transmitting an acknowledge packet. This is illustrated in FIG. 4 which shows four street lights A-D each having a node associated therewith.

If the receiving node B does not acknowledge (ACK) the packet before a timeout of a preset length occurs, the transmitting node A will retransmit the original packet again. This process of retransmitting until the receiving node B acknowledges the transmission can be repeated as many times as necessary, or until a maximum number of transmission attempts has been reached for the packet.

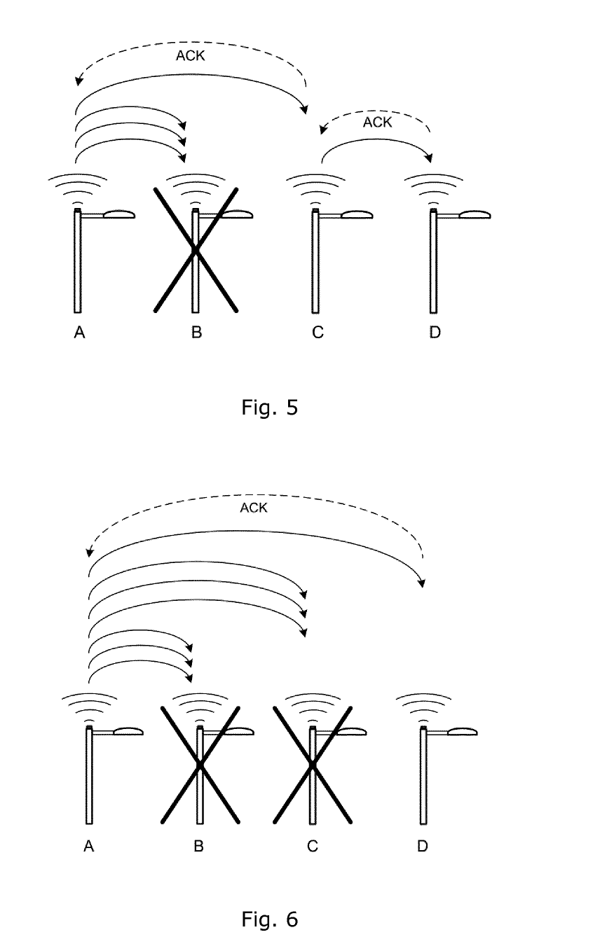

When the maximum number of unsuccessful transmission attempts for a specific packet from one network node A to a neighbouring network node B has been reached, it may be necessary for the transmitting node A to find an alternate route to the end destination of the packet. This is shown in FIG. 5.

Finding an alternate route to the destination can be done by examining the network graph, looking for neighbouring nodes of the unresponsive node B, excluding the transmitting node A itself. There may be any number of neighbouring nodes. If no neighbouring nodes exist, the transmitting node A can choose to stop the packet transmission, or to restart the process of transmitting to the unresponsive node B. If one or more neighbouring nodes are found, then the transmitting node may transmit the packet to all of the found neighbours.

If the neighbours themselves are unresponsive, then the transmitting node A can attempt to retransmit the packet to the neighbours, and may, if the neighbours continue to be unresponsive, attempt to find a new alternate route to the end destination of the packet. This is shown in FIG. 6. The process of finding alternate routes to the end destination of the packet may be repeated for as many levels of unresponsive nodes as the application designer sees fit. This decision could likely be based on the estimated maximal range of whatever communication medium is chosen.

Handling of Duplicate Packets

A node, called node B, may be able to receive packets from a particular neighbouring node, A, but may not be able to successfully transmit an acknowledge packet to node A. In this case, node B may transmit the received packet to the next hop node, C, in order for the packet to reach its destination node. The node that started the transmission sequence, A, may continue to retransmit the un-acknowledged packet, and may choose to find an alternate route to the packet destination node. This alternate route may include transmitting the packet to node C. Since node C has already received that particular packet from node B, the packet from node A should be discarded so the potential command stored in the packet is not executed twice, and superfluous transmissions are avoided. The mechanism by which node C is able to distinguish between the packets sent from node B and from node A is based on the relative age of the packet measured since the time of transmission from node A (assuming node A was the original transmitter of the packet). The packet from node A received by node C, will be older than the packet from node B received by node C, since the packet from node A will have one or more retransmission attempts before an alternate route to node C was found. Node C may choose to discard the packet from node A, since the packet seems to be an older version of an already received packet. The mechanism takes packet age jitter into account, by setting a time period of which a new packet must be newer than previously received packets in order to be accepted by the received node.

Network Configuration

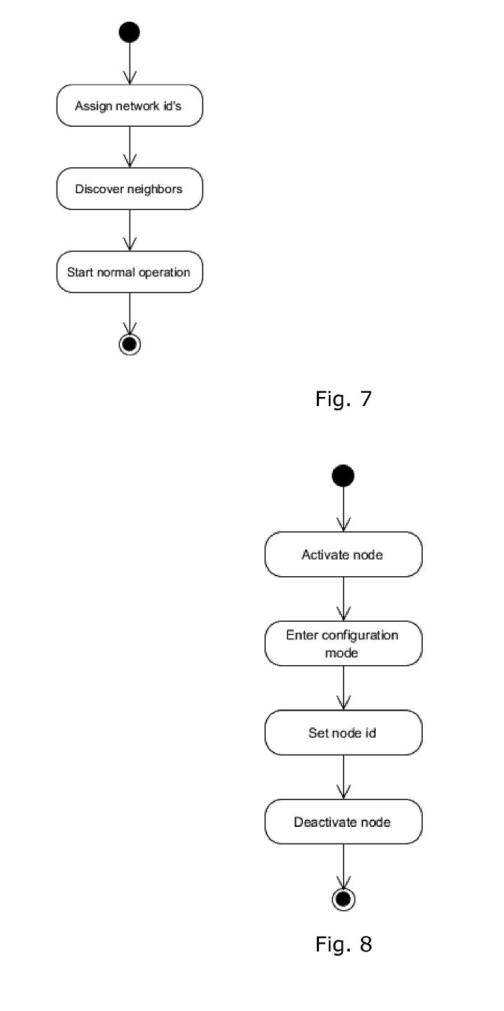

FIG. 7 shows the overall activities performed in the configuration process. The activities are performed after the nodes have been deployed in their final location. The first activity is to assign network id's to each individual node, thus making a mapping on each node between the nodes MAC address and the assigned node network id. The next activity is for each node to discover neighbouring nodes, i.e. the nodes that are in immediate communication range. The final activity is to let the nodes enter normal operation, thus ending the configuration process.

FIG. 8 elaborates on the activity of assigning a network id to a node, thus making a mapping between the nodes MAC address and the assigned network id. The first step is to activate the node. Activation methods includes, but is not limited to, enabling the power supply, inserting a dongle, inserting a fuse, activating a switch, visual or auditory cue and other methods. The next steps is to put the node into a configuration mode and then to transmit a network id to the node, which will then form and store a mapping between the nodes MAC address and the assigned network id, as well as the network id itself. The transmission of a network id to the node, could be performed in several ways, e.g. over a wired UART, by power line communication using the supply line or a dedicated line, by optical receivers/transmitters, by wireless receivers/transmitters and others methods. The final step is to deactivate the node, by reversing the operation performed to activate the node, e.g. by removing the power supply and so on.

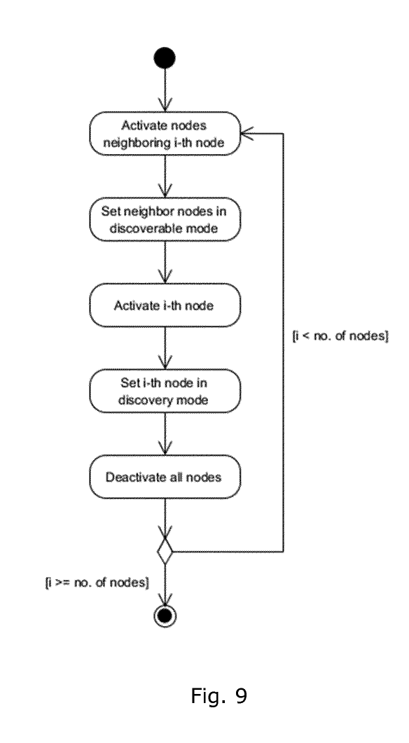

Once each node in the network has been assigned with a network id, the nodes are ready to form links between them, meaning that logical network connections are made, forming a route through the entire network of nodes by which communication messages can travel. FIG. 9 elaborates on the activity of discovering neighbours. Neighbour discovery is an activity that is performed by each individual node. Assuming that all nodes are deactivated, the first step is to activate the neighbouring nodes of the i-th node. The next step is to put the neighbouring nodes into a discoverable mode, meaning a mode in which the neighbouring nodes will respond to certain discover broadcast message with a network packet containing information about the responding nodes network id and MAC address, and other parameters if necessary. The next steps is to activate the i-th node and then set the i-th node to broadcast a discover message. The activated and discoverable neighbour nodes will reply to this discover message with the aforementioned information, and the i-th node now has information about its immediate network neighbourhood. The final step for the i-th node is to deactivate all activated nodes. The steps can be repeated for as many times as there are nodes in the network.

1. A method for operating a light source in order to reduce power usage, the method comprising the steps of
determining a predetermined traffic related activity, a nd
operating the light source in accordance with said determined traffic related activity.

2. A method according to claim 1, wherein the light intensity of the light source is varied in accordance with the determined traffic related activity.

3. A method according to claim 1, wherein the traffic related activity comprises a determination of an amount of traffic on or near the location of the light source.

4. A method according to claim 1, wherein the traffic related activity comprises a determination of a light intensity generated by the traffic on or near the location of the light source.

5. A method according to claim 1, wherein the light source forms part of a street light.

6. A method according to claim 1, wherein the light source is furthermore operated in accordance with one or more control signals provided by one or more sensors selected from the group consisting of: light sensor, photovoltaic sensor, temperature sensor, vibration sensor, sound sensor, pressure sensor, moisture sensor, humidity sensor, motion detection sensor, PIR sensor, radar sensor, gyro sensor, accelerometer, ice detector, electrical signal and wind/airflow sensor.

7. A method according to claim 1, wherein the light source comprises a LED.

8. A method according to claim 1, wherein the light source is operated in a constant light mode.

9. A street light comprising a light source, said street light further comprising
means for determining a predetermined traffic related activity, and
control means for operating the light source in accordance with said determined traffic related activity.

10. A street light according to claim 9, wherein the control means is adapted to vary the light intensity of the light source in accordance with the determined traffic related activity.

11. A street light according to claim 9, further comprising means for determining an amount of traffic on or near the location of the light source.

12. A street light according to claim 9, further comprising means for determining a light intensity generated by the traffic on or near the location of the light source.

13. A street light according to claim 9, further comprising one or more sensors selected from the group consisting of: light sensor, photovoltaic sensor, temperature sensor, vibration sensor, sound sensor, pressure sensor, moisture sensor, humidity sensor, motion detection sensor, PIR sensor, radar sensor, gyro sensor, accelerometer, ice detector, electrical signal and wind/airflow sensor.

14. A street light according to claim 9, wherein the light source comprises a LED.

15. A street light according to claim 9, further comprising communication means for communicating with one or more other street lights.

16. A street light according to claim 15, wherein the communication means comprises a wireless communication unit adapted to communicate with one or more neighbouring street lights in a wireless manner.

17. A street light according to claim 9, further comprising a power generating unit, such as a photovoltaic module or a wind power generator.

18. A network comprising a plurality of street lights according to claim 9.

19. A network according to claim 18, wherein each of the plurality of street lights comprises communication means for communicating with one or more other street lights.

20. A network according to claim 19, wherein the communication means comprises a wireless communication unit adapted to communicate with one or more neighbouring street lights in a wireless manner.
